(19) United States
(12) Patent Application Publication
(10) Pub. No.: US 2026/0088653 A1
(43) Pub. Date: Mar. 26, 2026

(54) VEHICLE

(71) Applicant: SUBARU CORPORATION, Tokyo (JP)

(72) Inventor: Manabu WATANABE, Shibuya-ku, Tokyo (JP)

(73) Assignee: SUBARU CORPORATION, Tokyo (JP)

(21) Appl. No.: 19/269,262

(22) Filed: Jul. 15, 2025

(30) Foreign Application Priority Data
Sep. 24, 2024 (JP) 2024-165332

(51) Int. Cl. H02J 50/00; B60D 1/04; B60D 1/06; B60D 1/64; B60L 9/00; B60L 50/60; B60L 53/122; B60L 53/16; H02J 7/34; H02J 50/10

(52) U.S. Cl. CPC H02J 50/005; B60D 1/64; B60L 9/00; B60L 53/122; B60L 53/16; H02J 7/342; H02J 50/10; B60D 1/04; B60D 1/06; B60L 50/66

(57) ABSTRACT

A vehicle includes a towing member, an in-vehicle battery, a power receiving coil, a holder, and a lift. The power receiving coil is configured to receive magnetic flux from a power feed coil included in a towed object and to generate power. The holder is configured to hold the power feed coil directly below the power receiving coil. The lift is configured to position the power receiving coil at a first height corresponding to a minimum ground clearance of the vehicle, in a state in which the holder does not hold the power feed coil. The lift is configured to position the power receiving coil at a second height, which is a height of the power receiving coil at which the power feed coil is at a height that corresponds to the minimum ground clearance of the vehicle, in a state in which the holder holds the power feed coil.

### CROSS-REFERENCE TO RELATED APPLICATIONS

The present application claims priority from Japanese Patent Application No. 2024-165332 filed on Sep. 24, 2024, the entire contents of which are hereby incorporated by reference.

### BACKGROUND

The disclosure relates to a vehicle that contactlessly charges a secondary battery installed in the vehicle.

Electric vehicles that can travel without using fuel such as gasoline or the like, and hybrid vehicles that can travel both on fuel and electricity, are becoming more commonplace. In order to extend distances that such vehicles can travel on a single charge, increasing the size of an in-vehicle battery that is installed in the vehicle is conceivable. However, there is a likelihood that increasing the size of the in-vehicle battery would increase the weight of the vehicle and make securing space in which to install the in-vehicle battery difficult.

Japanese Unexamined Patent Application Publication (JP-A) No. 2003-158802 discloses a configuration in which a power generating unit is installed in a towed vehicle that is towed by a vehicle. In this configuration, when the vehicle is traveling long distances, the towed vehicle is linked to the vehicle, and the in-vehicle battery is charged using a power generating unit that is installed in the towed vehicle.

### SUMMARY

A vehicle according to one aspect of the disclosure includes a towing member, an in-vehicle battery, a power receiving coil, a holder, and a lift. The towing member is configured to link with a towed object. The in-vehicle battery serves as a secondary battery in the vehicle. The power receiving coil is configured to receive a magnetic flux generated in a power feed coil that is coupled to an external battery that is installed in the towed object, and generate power to be used for charging the in-vehicle battery. The power receiving coil is disposed below a floor panel. The holder is configured to hold the power feed coil directly below the power receiving coil. The lift is configured to raise and lower the power receiving coil. The lift is configured to position the power receiving coil at a first height corresponding to a minimum ground clearance of the vehicle, in a state in which the power feed coil is not held by the holder. The lift is configured to position the power receiving coil at a second height, in a state in which the power feed coil is held by the holder. The second height is a height of the power receiving coil at which the power feed coil is at a height that corresponds to the minimum ground clearance of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic block diagram illustrating a configuration of a vehicle and a power feed coil that is embedded in the ground, according to an embodiment of the disclosure;

FIG. 2 is a schematic block diagram illustrating a configuration of the vehicle and a towed object that is towed by the vehicle;

FIG. 3 is a disassembled perspective view illustrating a configuration of a holder and a lift;

FIG. 4 is a perspective view illustrating a state in which parts making up the holder and the lift are assembled together;

FIG. 5 is a top view of the holder and the lift; and

FIG. 6 is a diagram illustrating a state in which a power receiving coil is situated at a first position;

FIG. 7 is a diagram illustrating a state in which the power receiving coil is situated at a lower end position;

FIG. 8 is a diagram illustrating the state in which the power receiving coil is situated at the lower end position, in a state in which the holder holds the power feed coil;

FIG. 9 is a diagram illustrating a state in which the power receiving coil is situated at a second position; and

FIG. 10 is a diagram illustrating an example of a configuration of the power feed coil that is coupled to an external battery installed in the towed object.

### DETAILED DESCRIPTION

In a configuration disclosed in JP-A No. 2003-158802, a portion of a vehicle that receives power that is supplied from a power generating unit is equipment that can be utilized just when a towed vehicle is being towed. Accordingly, in vehicles that have power receiving equipment capable of handling charging lanes that enable charging while traveling, some of the equipment is included redundantly, leaving room for improvement with respect to reduction of vehicle weight and vehicle size.

The disclosure includes a configuration that enables an in-vehicle battery to be charged while traveling, and also simplifies the configuration thereof.

An embodiment of a vehicle 1 according to the disclosure will be described below with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

The description will be provided in the following order: 1. Configuration of Vehicle, 2. Configuration of Holder and Lift, 3. Configuration of Power Feed Coil, 4. Operations of Holder and Lift, 5. Other, and 6. Summarization.

### 1. Configuration of Vehicle

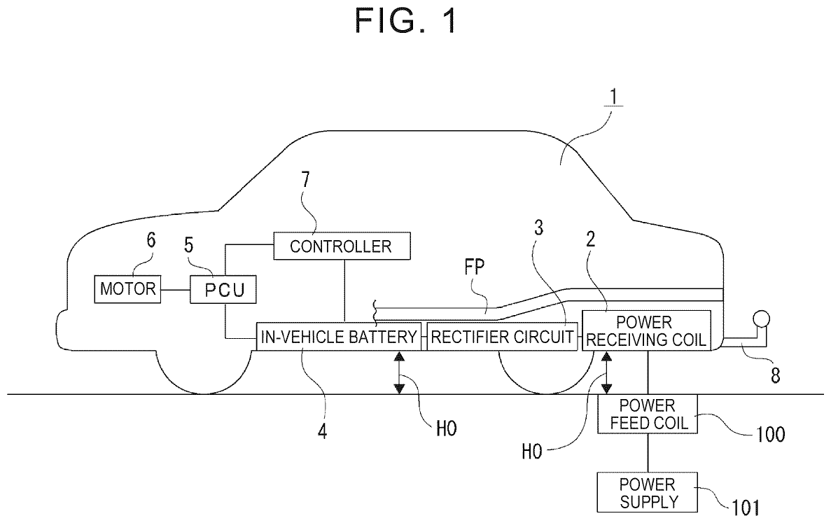

FIG. 1 is a diagram illustrating an example of a configuration of the vehicle 1 that is an electric vehicle. The vehicle 1 is configured to perform contactless charging utilizing a power feed coil 100 that is embedded in the ground.

An alternating current flows through the power feed coil 100 from a power supply 101 that is an alternating current power supply that is embedded in the ground or installed on the ground.

In the power feed coil 100, a magnetic flux is generated by a flow of the alternating current.

The vehicle 1 includes a power receiving coil 2, a rectifier circuit 3, an in-vehicle battery 4, a power control unit (PCU) 5, a motor 6, and a controller 7.

An alternating current is generated in the power receiving coil 2 by the magnetic flux that is generated in the power feed coil 100. That is to say, power is transmitted between the power feed coil 100 and the power receiving coil 2 in a contactless manner.

The alternating current that is generated in the power receiving coil 2 is supplied to the rectifier circuit 3. The rectifier circuit 3 serves as an alternating current (AC)/direct current (DC) conversion circuit. The rectifier circuit 3 converts alternating current voltage of the alternating current that is received into direct current voltage, and supplies the direct current voltage to the in-vehicle battery 4.

The in-vehicle battery 4 is a high-voltage secondary battery. The in-vehicle battery 4 supplies power that is used to drive wheels and to drive various types of electronic equipment of the vehicle 1. FIG. 1 illustrates power supply when power that is used to drive the wheels is supplied from the in-vehicle battery 4. In FIG. 1, power supply from the in-vehicle battery 4, in a case of supplying power to be used for driving various parts other than the wheels, is omitted from illustration.

The in-vehicle battery 4 is charged based on the direct current voltage that is supplied from the rectifier circuit 3. That is to say, the power feed coil 100 and the power supply 101 that are embedded in the ground, and the power receiving coil 2 and the rectifier circuit 3 of the vehicle 1, enable contactless charging of the in-vehicle battery 4.

The in-vehicle battery 4 supplies the PCU 5 with a power supply voltage for driving the motor 6.

The Pcu 5 includes an inverter, a DC/DC converter, and so forth, for driving the motor 6.

The PCU 5 generates an alternating current for driving the motor 6 based on the aforementioned power supply voltage, and supplies the alternating current that is generated to the motor 6. The PCU 5 controls torque of the motor 6 by controlling the alternating current. Also, the PCU 5 may include a regenerative braking function, thereby including an energy efficiency optimizing function utilizing regenerative energy.

The motor 6 is configured as a motor-generator including a power generating function, and drives the wheels based on the alternating current that is supplied.

The controller 7 includes a central processing unit (CPU), memory, and the like, and performs overall control of the vehicle 1. The controller 7 may be provided as a single unit, or may be made up of a plurality of electronic control units (ECUs). The ECUs may include various types of ECUs, such as, for example, a battery control ECU, a display control ECU, an airbag control ECU, and an air conditioning control ECU. The battery control ECU performs charging control of the in-vehicle battery 4, and so forth. The display control ECU performs display control and so forth for display devices (including meters, and so forth) that the vehicle 1 includes. That is, the controller 7 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the controller 7. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the controller 7.

Although not illustrated in FIG. 1, the in-vehicle battery 4 may be capable of being charged via a connector that is provided to the vehicle 1.

The controller 7 calculates and manages a state of charge (SOC) of the in-vehicle battery 4 using measured values such as output current value, output voltage value, and so forth, of the in-vehicle battery 4. Note that the PCU 5 may manage information regarding the SOC, and the controller 7 may be capable of obtaining the SOC from the PCU 5. The controller 7 is capable of performing control in accordance with the SOC.

Note that the height of the in-vehicle battery 4 and the power receiving coil 2 from the ground is set to a height that can ensure a minimum ground clearance that is set for the vehicle 1. In the following description, the minimum ground clearance of the vehicle 1 will be referred to as “minimum ground clearance”H0.

The vehicle 1 is configured to charge the in-vehicle battery 4, not just in the contactless manner utilizing the power feed coil 100 that is embedded in the ground as illustrated in FIG. 1, but also to charge the in-vehicle battery 4 in a different manner.

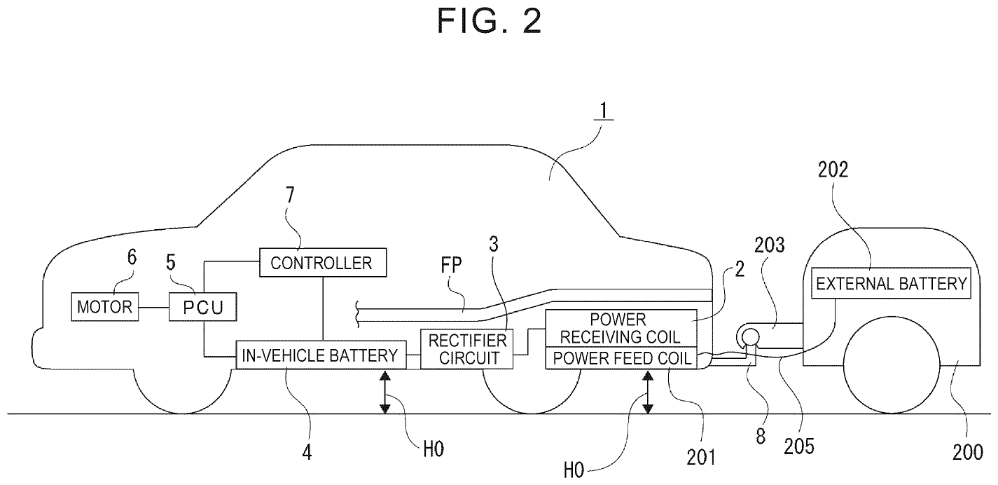

As illustrated in FIG. 2, the vehicle 1 in this embodiment is configured to contactlessly charge the in-vehicle battery 4 by utilizing a power feed coil 201 and an external battery 202. The power feed coil 201 is included in a towed object 200, which is towed by a vehicle 1.

The vehicle 1 includes a towing member 8 configured to tow the towed object 200. Various configurations are conceivable for the towing member 8. For example, the towing member 8 of the vehicle 1 may be configured including a ball pin, may be configured including a coupler, may be configured including a hitch ball, and may be configured including a hook. The ball pin is configured to be linked with a slot that the towed object 200 includes. The coupler is configured such that the towed object 200 is linked therewith. The hitch ball is configured such that a coupler that the towed object 200 includes is linked therewith. The hook is configured such that a ring that the towed object 200 includes is linked therewith.

The slot, coupler, ring, or the like, that the towed object 200 includes, are referred to as “towed member” 203. That is to say, the towed member 203 is linked to the towing member 8 in various ways.

In the vehicle 1, power transmission is performed between the power feed coil 201 that is coupled to the external battery 202 and the power receiving coil 2 as described above, thereby charging the in-vehicle battery 4.

The vehicle 1 also includes a holder 9 that holds the power feed coil 201 below the power receiving coil 2.

Furthermore, the vehicle 1 includes a lift 10. The lift 10 is configured to lift the power receiving coil 2 such that the minimum ground clearance H0 can be ensured for the height of the power feed coil 201 in a state of holding the power feed coil 201 directly below the power receiving coil 2.

Note that as illustrated in FIGS. 1 and 2, in the vehicle 1, at least the power receiving coil 2 and the in-vehicle battery 4 are disposed below a floor panel FP. Also, the holder 9 that holds the power feed coil 201 and the lift 10 are also disposed below the floor panel FP.

Note that the holder 9 and the lift 10 are not illustrated in FIGS. 1 and 2.

It can be understood from FIGS. 1 and 2 that the power receiving coil 2 that the vehicle 1 includes can generate alternating current by utilizing the magnetic flux that is generated not just at the power feed coil 100 that is embedded in the ground, but also at the power feed coil 201 that is included in the towed object 200.

That is to say, the power receiving coil 2 that the vehicle 1 includes is utilized in any of first contactless charging, second contactless charging, and third contactless charging. The first contactless charging is performed while the vehicle is parked, utilizing a power feed coil 100 that is embedded in a parking lot. The second contactless charging is performed while the vehicle is traveling, utilizing a power feed coil 100 that is embedded in a charging lane. The third contactless charging is performed utilizing the external battery 202 that is installed in the towed object 200 and the power feed coil 201. That is to say, the vehicle 1 includes one power receiving coil 2 that can be utilized for a wide variety of contactless charging methods relating to the in-vehicle battery 4.

### 2. Configuration of Holder and Lift

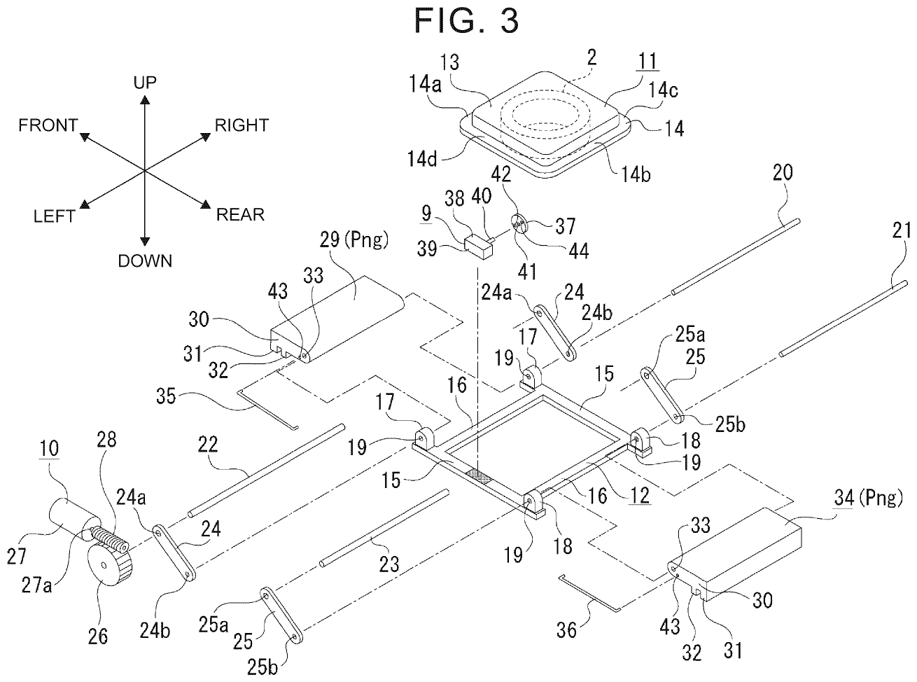

Examples of the holder 9 and the lift 10 that the vehicle 1 includes are illustrated in FIGS. 3, 4 and 5. Note that in the following description, a direction along which the vehicle 1 travels when advancing or reversing will be referred to as “front-rear direction”, and a vehicle width direction is referred to as “right-left direction”. Also, the rightward and leftward in the right-left direction refer to the directions in a state of facing frontward.

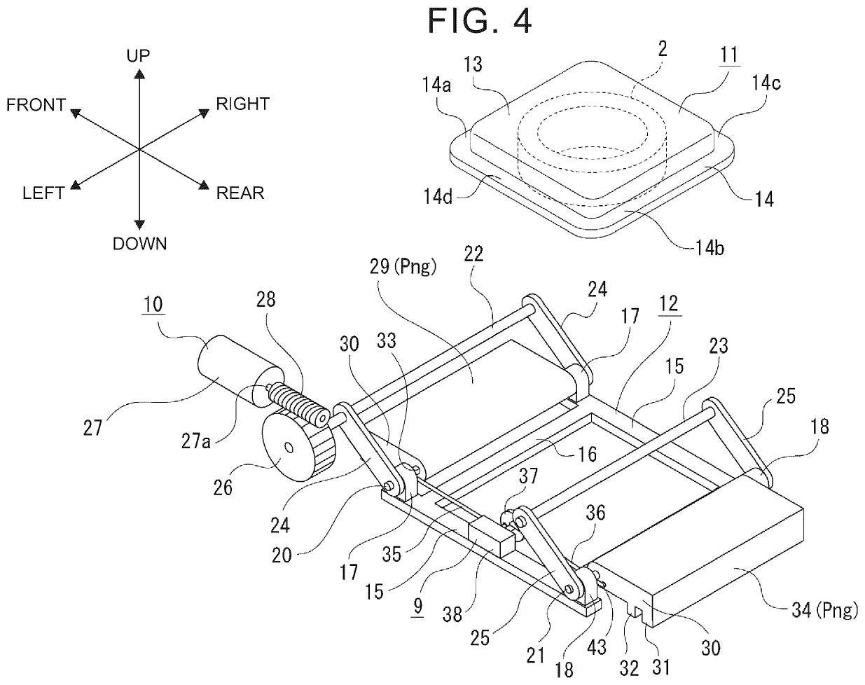

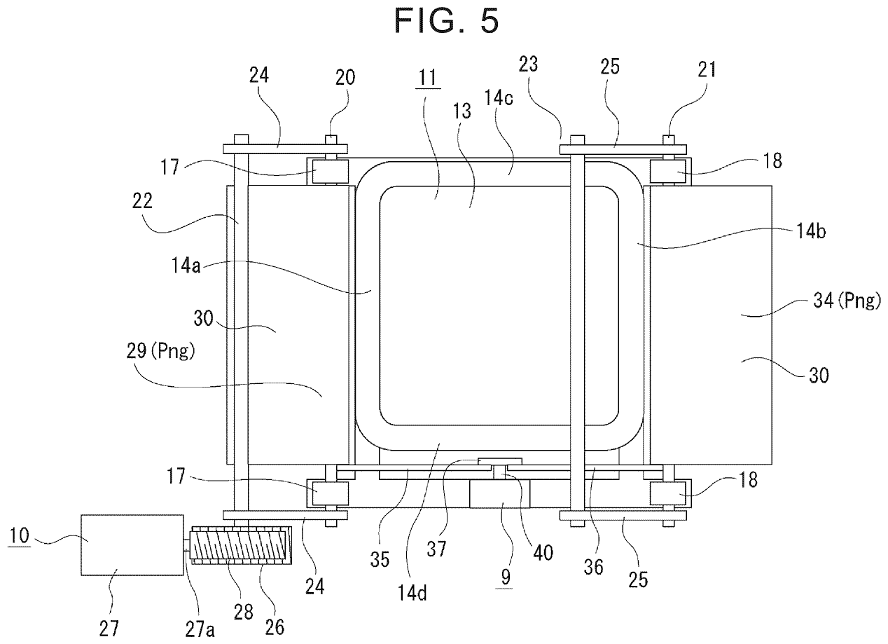

FIG. 3 is a disassembled perspective view illustrating the holder 9 and the lift 10 in a disassembled state. FIG. 4 is a perspective view illustrating a combination of components of the holder 9 and the lift 10 along with the power receiving coil 2. FIG. 5 is a diagram illustrating components of the holder 9 and the lift 10 in an assembled state, as viewed from above.

The power receiving coil 2 that the vehicle 1 includes is housed inside a power receiving coil case 11.

The power receiving coil case 11 is fixed to a frame 12.

The power receiving coil case 11 has, for example, a case body 13 that is box-shaped, and a flange portion 14 that protrudes in a lateral direction from substantially a middle portion of the case body 13 in an up-down direction. The flange portion 14 includes a frontward flange portion 14a, a rearward flange portion 14b, a rightward flange portion 14c, and a leftward flange portion 14d. The frontward flange portion 14a is situated forward relative to the case body 13. The rearward flange portion 14b is situated rearward relative to the case body 13. The rightward flange portion 14c is situated rightward relative to the case body 13. The leftward flange portion 14d is situated leftward relative to the case body 13.

The frame 12 is frame-shaped. The frame 12 includes two first frames 15, and two second frames 16. The two first frames 15 each extend in the front-rear direction and are disposed spaced apart from each other in the left-right direction, and the two second frames 16 each extend in the right-left direction and are disposed spaced apart from each other in the front-rear direction.

The power receiving coil case 11 is fixed to the frame 12 in a state in which the flange portion 14 is situated at an upper part of the frame 12. The frontward flange portion 14a and the rearward flange portion 14b of the flange portion 14 are fixed to the two second frames 16 from above. Also, the rightward flange portion 14c of the flange portion 14 is fixed from above to the first frame 15 that is situated on the right side, out of the two first frames 15.

Various methods, such as screwing, bolt fastening, or the like, can be used for a method of fixing.

On the other hand, the leftward flange portion 14d of the flange portion 14 is disposed rightward from the first frame 15 that is situated leftward. In other words, the leftward flange portion 14d is not fixed to the first frame 15.

The power receiving coil case 11 is fixed to the frame 12 and thus is supported by the frame 12. The power receiving coil case 11 is moved integrally with the frame 12.

Protrusions are provided on an upper face of each of the two first frames 15. The protrusions are disposed at both ends of each of the two first frames 15 in the front-rear direction. The protrusions that are provided on a front end side of the first frames 15 will be referred to as “front-side protrusions” 17. The protrusions that are provided on a rear end side of the first frames 15 will be referred to as “rear-side protrusions”18.

The front-side protrusions 17 and the first frames 15 may be made from a single member. The front-side protrusions 17 and the first frames 15 may be made as separate members, and the front-side protrusions 17 may be fixed to the first frames 15 from above. The rear-side protrusions 18 and the first frames 15 may be made from a single member. The rear-side protrusions 18 and the first frames 15 may be made as separate members, and the rear-side protrusions 18 may be fixed to the first frames 15 from above.

Each of the front-side protrusions 17 and the rear-side protrusions 18 has a through hole 19 passing therethrough in the right-left direction.

A front-side shaft member 20 that is shaped as a rod and that extends in the right-left direction is inserted through each of the through holes 19 of the two front-side protrusions 17.

A rear-side shaft member 21 having the same shape as the front-side shaft member 20 is inserted through each of the through holes 19 of the two rear-side protrusions 18.

A pair of cross bars that are situated extending in the right-left direction and spaced apart from each other in the front-rear direction is provided on a lower portion rearward in a vehicle body of the vehicle 1. Of the pair of cross bars, the one situated frontward will be referred to as “front-side cross bar” 22, and the one situated rearward will be referred to as “rear-side cross bar”23.

The front-side cross bar 22 and the rear-side cross bar 23 are fixed to the vehicle body, and orientations and the positions thereof relative to the vehicle body are unchangeable.

One end in the front-rear direction of a first link 24 is attached to each of the right and left ends of the front-side cross bar 22. One end in the front-rear direction of each of the first links 24 has a rotation center hole 24a that passes through in the right-left direction. The positions of the first links 24 are fixed relative to the front-side cross bar 22 by inserting the front-side cross bar 22 through the rotation center holes 24a. Note, however, that the first links 24 are capable of turning relative to the front-side cross bar 22, about the rotation center holes 24a as a center of turning.

Note that right-left direction movement of the first links 24 relative to the front-side cross bar 22 is restricted by a mechanism that is omitted from illustration.

The first links 24 each have an attachment hole 24b at an end thereof opposite to the rotation center hole 24a in the front-rear direction. Ends of the front-side shaft member 20 are rotatably inserted into the attachment holes 24b.

One end in the front-rear direction of a second link 25 is attached to each of right and left ends of the rear-side cross bar 23. One end in the front-rear direction of each of the second links 25 has a rotation center hole 25a that passes through in the right-left direction. The positions of the second links 25 are fixed relative to the rear-side cross bar 23 by inserting the rear-side cross bar 23 through the rotation center holes 25a. Note, however, that the second links 25 are capable of turning relative to the rear-side cross bar 23, about the rotation center holes 25a as a center of turning.

Note that right-left direction movement of the second links 25 relative to the rear-side cross bar 23 is restricted by a mechanism that is omitted from illustration.

The second links 25 each have an attachment hole 25b at an end thereof opposite to the rotation center hole 25a in the front-rear direction. Ends of the rear-side shaft member 21 are rotatably inserted into the attachment holes 25b.

The frame 12 is indirectly supported by the front-side cross bar 22 and the rear-side cross bar 23 by four links, namely, the two first links 24 and the two second links 25.

The first links 24 turn relative to the front-side cross bar 22 with the rotation center holes 24a as the center of rotation. Also, the second links 25 turn relative to the rear-side cross bar 23 with the rotation center holes 25a as the center of rotation. Thus, the frame 12 is turned in an arc relative to the front-side cross bar 22 and the rear-side cross bar 23.

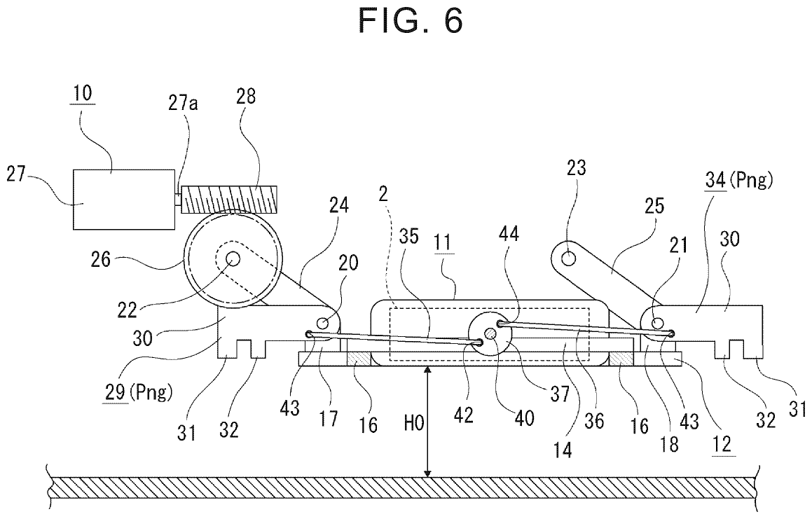

The position of the frame 12 can be varied in the front-rear direction and the up-down direction relative to the vehicle body while the orientation thereof relative to the vehicle body remains unchanged (see the drawings in FIGS. 6 to 9).

A first gear 26 is attached to an end of the front-side cross bar 22 in the right-left direction thereof, at a position further outward than a portion to which the first link 24 is attached. A rotation axis of the first gear 26 extends in the right-left direction and the first gear 26 rotates integrally with the turning of the first link 24.

The lift 10 of the vehicle 1 includes a first motor 27 and a second gear 28. The first motor 27 is attached to the lower part of the vehicle body, and the orientation and the position thereof relative to the vehicle body are fixed. The second gear 28 is attached to a rotating shaft 27a of the first motor 27.

The second gear 28 is, for example, a worm gear, and is disposed in a state in which it meshes with the first gear 26.

When drive voltage is applied to the first motor 27 to rotate the rotating shaft 27a, the second gear 28 that is attached to the rotating shaft 27a rotates, and accordingly the first gear 26 meshing with the second gear 28 rotates.

The first gear 26 and the first link 24 rotate integrally, and accordingly the first link 24 rotates along with the rotation of the first gear 26. Thus, the frame 12 and the power receiving coil case 11 that is held by the frame 12 move in the front-rear direction and the up-down direction relative to the vehicle body by the two first links 24 and the two second links 25.

A frontward grip 29 is attached to the front-side shaft member 20 between the two front-side protrusions 17.

The frontward grip 29 is substantially letter-F shaped as viewed from the right-left direction. The frontward grip 29 has a base 30, a first gripping piece 31, and a second gripping piece 32.

One end of the base 30 in the front-rear direction has a support hole 33. The front-side shaft member 20 is inserted through the support hole 33.

The first gripping piece 31 is disposed farther away from the support hole 33 than the second gripping piece 32 is. The base 30 and the first gripping piece 31 form an L shape as viewed from the right-left direction.

The second gripping piece 32 protrudes in the same direction as the first gripping piece 31, from a portion in the base 30 between the support hole 33 and the first gripping piece 31.

A rearward grip 34 is attached to the rear-side shaft member 21, at a portion between the two rear-side protrusions 18.

The rearward grip 34, like the frontward grip 29, is substantially letter-F shaped as viewed from the right-left direction. Also, the frontward grip 29 and the rearward grip 34 are symmetrical with respect to an axis extending in the up-down direction as viewed in the right-left direction.

In the same way as with the frontward grip 29, the rearward grip 34 includes the base 30, the first gripping piece 31, and the second gripping piece 32. The base 30 has the support hole 33.

The holder 9 of the vehicle 1 includes a third link 35, a fourth link 36, a rotating member 37, and a second motor 38.

The second motor 38 includes a body 39 that is box-shaped, and a drive shaft 40 protruding from the body 39.

The body 39 is fixed to an upper face (portion indicated by hatching in FIG. 3) at substantially the middle of the first frame 15 that is situated on the left side out of a pair of the first frames 15 of the frame 12.

The rotating member 37 is attached to the drive shaft 40 of the second motor 38 so as to rotate integrally with the drive shaft 40. The rotating member 37 has a hole into which the drive shaft 40 is inserted. This hole is a hole that is the center of rotation of the rotating member 37, and is referred to as “rotation center hole”41.

One end of the third link 35 in the front-rear direction is inserted into a first link hole 42 of the rotating member 37. The first link hole 42 faces the same direction as the rotation center hole 41 at a position in the rotating member 37 that is different from the position of the rotation center hole 41.

Also, the other end of the third link 35 in the front-rear direction is inserted into a linking hole 43 that is provided in the frontward grip 29. The linking hole 43 faces the same direction as the support hole 33 at a position in the frontward grip 29 that is different from the position of the support hole 33.

The linking hole 43 in the frontward grip 29 may be provided in any of the base 30, the first gripping piece 31, or the second gripping piece 32, but is provided in the base 30 in this embodiment.

One end of the fourth link 36 in the front-rear direction is inserted into a second link hole 44 of the rotating member 37. The second link hole 44 faces the same direction as the rotation center hole 41, at a position in the rotating member 37 that is different from the positions of the rotation center hole 41 and the first link hole 42.

Also, the other end of the fourth link 36 in the front-rear direction is inserted into the linking hole 43 that is provided in the rearward grip 34. The linking hole 43 faces the same direction as the support hole 33 at a position in the rearward grip 34 that is different from the position of the support hole 33.

The linking hole 43 in the rearward grip 34 may be provided in any of the base 30, the first gripping piece 31, or the second gripping piece 32, but is provided in the base 30 in this embodiment.

As illustrated in each of FIGS. 6 to 9, when drive voltage is applied to the second motor 38 to rotate the drive shaft 40, the rotating member 37 rotates integrally with the drive shaft 40.

When the rotating member 37 rotates, the positions of one end of the third link 35 in the front-rear direction and one end of the fourth link 36 in the front-rear direction change, and the distance between the rotating member 37 and the frontward grip 29, and the distance between the rotating member 37 and the rearward grip 34, change.

Accordingly, the frontward grip 29 turns about the front-side shaft member 20 as a center of turning, and the rearward grip 34 turns about the rear-side shaft member 21 as a center of turning.

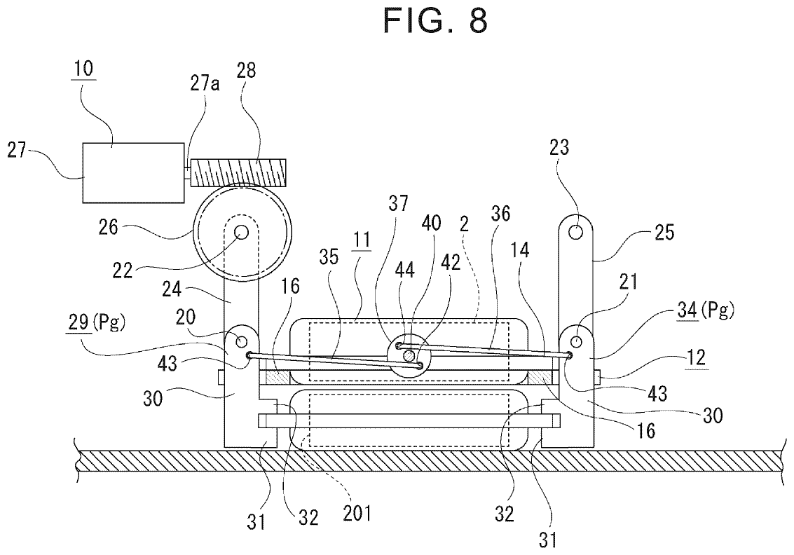

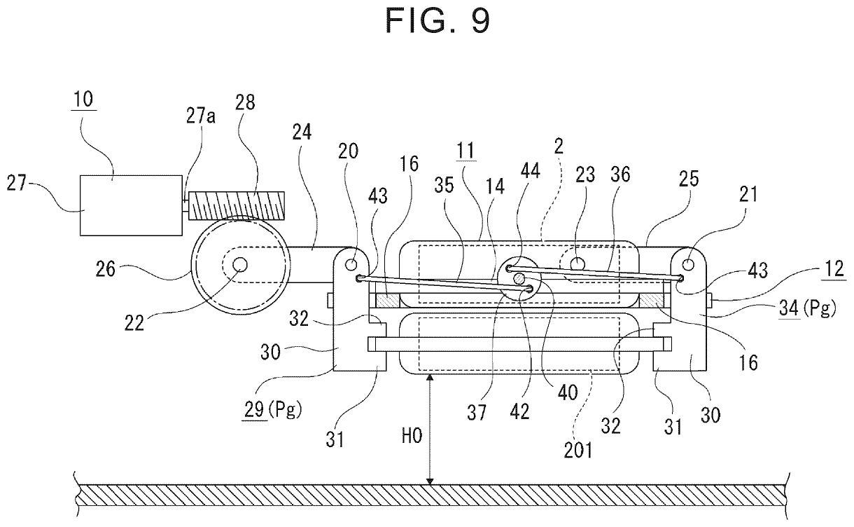

Note that in a state illustrated in FIG. 6, in which a recess that is formed by the first gripping piece 31, the second gripping piece 32, and the base 30 of the frontward grip 29, opens substantially downward, is referred to as “non-gripping position” Png. Also, in states illustrated in FIGS. 8 and 9, in which the recess that is formed by the first gripping piece 31, the second gripping piece 32 and the base 30 of the frontward grip 29 opens substantially rearward, is referred to as “gripping position”Pg.

In the same way for the rearward grip 34, the state in which the recess that is formed by the first gripping piece 31, the second gripping piece 32, and the base 30 opens substantially downward is the non-gripping position Png, and a state in which the recess opens substantially frontward is the gripping position Pg.

### 3. Configuration of Power Feed Coil

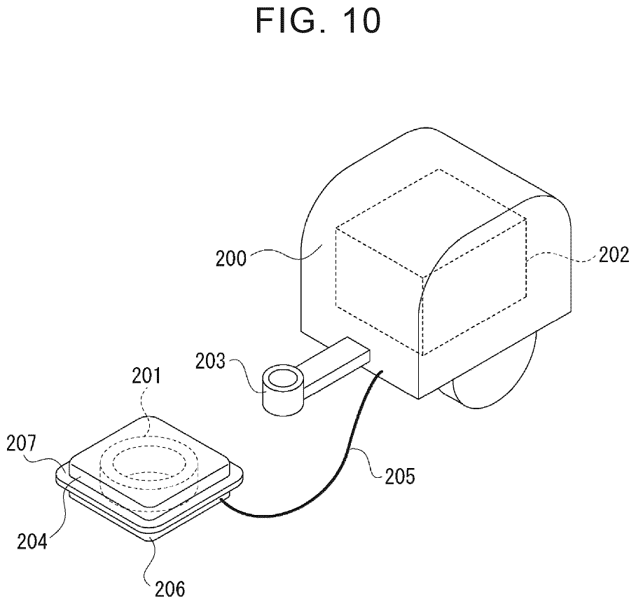

A configuration of the power feed coil 201 is as illustrated in FIG. 10. The power feed coil 201 is housed inside a power feed coil case 204. Also, a flexible cable 205 that is coupled to the external battery 202 installed in the towed object 200 is coupled to the power feed coil 201.

The flexible cable 205 may be led out from a case of the towed object 200 to space outside of the towed object 200. The flexible cable 205 may be led out from the towed member 203 that protrudes frontward from the case of the towed object 200 to the space outside of the towed object 200.

The power feed coil case 204 has a case body 206, and a flange portion 207 that protrudes in a lateral direction from substantially a middle portion of the case body 206 in the up-down direction.

The thickness of the flange portion 207 is approximately the same as the distance between the opposing faces of the first gripping piece 31 and the second gripping piece 32 in the frontward grip 29 of the holder 9 of the vehicle 1. That is to say, the flange portion 207 of the power feed coil case 204 serves as a gripped portion that is gripped by the frontward grip 29 and the rearward grip 34 of the holder 9.

### 4. Operations of Holder and Lift

The operations of the holder 9 and the lift 10 will be described with reference to FIGS. 6 to 9.

FIG. 6 illustrates a state in which the holder 9 is not holding the power feed coil 201, and charging control of the in-vehicle battery 4 using the power feed coil 201 and the power receiving coil 2 is not being performed.

A lower end of the power receiving coil 2 in the state illustrated in FIG. 6 is disposed so as to ensure the minimum ground clearance H0 of the vehicle 1. The position of the power receiving coil 2 illustrated in FIG. 6 is referred to as “first position” P1. Also, the height of the power receiving coil 2 from the road surface in the state of being situated at the first position P1 is defined as “first height” H1. The first height H1 is a value that is greater than the minimum ground clearance H0.

In the state in which the power receiving coil 2 is situated at the first position P1, the frontward grip 29 and the rearward grip 34 are both situated in the non-gripping position Png. Note that the non-gripping position Png is also a position where the minimum ground clearance H0 of the vehicle 1 is ensured.

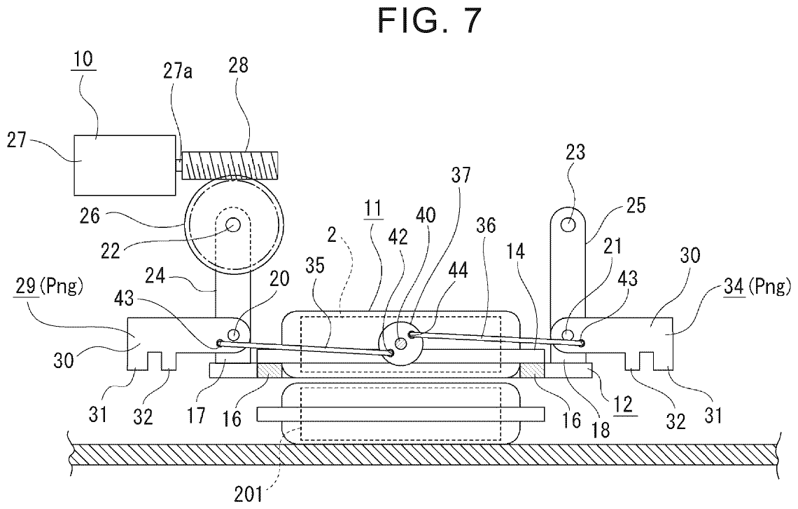

A case in which charging of the in-vehicle battery 4 is started using the power feed coil 201 and the power receiving coil 2 will be described. In this case, the controller 7 of the vehicle 1 first moves the power receiving coil 2 downward by the lift 10, in a state in which the power feed coil 201 is positioned below the power receiving coil 2, as illustrated in FIG. 7. The position of the power receiving coil 2 illustrated in FIG. 7 is a position at which the power receiving coil 2 has been moved downward in order to perform holding of the power feed coil 201, and this position is referred to as “lower end position” PL. Also, the height of the power receiving coil 2 from the road surface in the state of being situated at the lower end position PL is defined as a height HL. The height HL is smaller value than the minimum ground clearance H0.

Next, the controller 7 of the vehicle 1 moves the frontward grip 29 and the rearward grip 34 of the holder 9 from the non-gripping position Png to the gripping position Pg, in the state in which the power receiving coil 2 is positioned at the lower end position PL, as illustrated in FIG. 8.

At this time, the first gripping piece 31 of the frontward grip 29 is situated below the flange portion 207 of the power feed coil 201, and the second gripping piece 32 of the frontward grip 29 is situated above the flange portion 207. In the same way, the first gripping piece 31 and the second gripping piece 32 of the rearward grip 34 are situated below and above the flange portion 207, respectively.

Thus, the power feed coil 201 is held directly below the power receiving coil 2 by the holder 9 of the vehicle 1.

Next, the controller 7 of the vehicle 1 moves the power receiving coil 2 upward by the lift 10, as illustrated in FIG. 9.

The power receiving coil 2 illustrated in FIG. 9 is disposed at a second position P2 upward from the first position P1. Also, the height of the power receiving coil 2 from the road surface in the state of being situated at the second position P2 is defined as “second height” H2. The second height H2 is a value greater than the minimum ground clearance H0 and is also a value greater than the first height H1. The second height H2 is set to a value greater than the first height H1 by at least the height of the case body 206.

The second height H2 is set such that the lowermost ends of the power feed coil 201 and the case body 206 in the state of being held by the holder 9 are situated higher than the minimum ground clearance H0 of the vehicle 1. This enables the in-vehicle battery 4 to be suitably charged using the power feed coil 201 and the power receiving coil 2 while the vehicle 1 is traveling.

### 5. Other

The distance between the opposing faces of the first gripping piece 31 and the second gripping piece 32 of the frontward grip 29 may be different in the state of the first gripping piece 31 and the second gripping piece 32 gripping the flange portion 207 of the power feed coil 201 and in the state of not gripping the flange portion 207. For example, the distance between the opposing faces of the first gripping piece 31 and the second gripping piece 32 in the state of the flange portion 207 not being gripped is longer than the thickness of the flange portion 207. The distance between the opposing faces of the first gripping piece 31 and the second gripping piece 32 in the state of gripping the flange portion 207 may be approximately the same length as the thickness of the flange portion 207. The same applies to the first gripping piece 31 and the second gripping piece 32 of the rearward grip 34.

Also, the frontward grip 29 may be provided with a locking mechanism or the like for maintaining the state in which the first gripping piece 31 and the second gripping piece 32 grip the flange portion 207. The same applies to the rearward grip 34. Thus, the power feed coil 201 and other components can be suppressed from falling out of the holder 9 of the vehicle 1.

### 6. Summarization

The vehicle 1 of the disclosure includes the towing member 8 to which the towed object 200 is linked, the in-vehicle battery 4 that serves as an in-vehicle secondary battery, the power receiving coil 2 that is disposed below the floor panel FP and configured to receive magnetic flux generated in the power feed coil 201 that is coupled to the external battery 202 installed in the towed object 200 to generate power to be used to charge the in-vehicle battery 4, the holder 9 configured to hold the power feed coil 201 directly below the power receiving coil 2, and the lift 10 configured to raise and lower the power receiving coil 2. Also, the lift 10 is configured to position the power receiving coil 2 at the first height H1 that corresponds to the minimum ground clearance H0 of the vehicle 1 in the state in which the holder 9 is not holding the power feed coil 201. The lift 10 is configured to position the power receiving coil 2 at the second height H2 in the state in which the holder 9 holds the power feed coil 201. The second height H2 is the height of the power receiving coil 2 at which the power feed coil 201 is at the height corresponding to the minimum ground clearance H0.

For example, the power receiving coil 2 installed at the bottom portion of the vehicle 1 is disposed at a height such that the lower end of the power receiving coil 2 is approximately the minimum ground clearance H0 in the state in which the holder 9 is not holding the power feed coil 201. Also, the power receiving coil 2 is disposed such that, in the state in which the holder 9 holds the power feed coil 201, both the power feed coil 201 and the power receiving coil 2 are higher than the minimum ground clearance H0. Thus, in the state in which the power feed coil 201 is not held, for example, a charging lane in which the power feed coil 100 is embedded in the ground can be utilized to charge the in-vehicle battery 4 while traveling. By positioning the power receiving coil 2 so as to be situated as low as possible while still ensuring the minimum ground clearance H0, charging efficiency when a traveling lane is utilized can be improved. Also, in the state in which the power feed coil 201 is held, the in-vehicle battery 4 can be charged using the external battery 202 that is installed in the towed object 200 even when traveling in a region where no charging lane facilities exist, thereby enabling cruising range of the vehicle 1 to be extended. By disposing both the power feed coil 201 and the power receiving coil 2 so as to ensure the minimum ground clearance H0, contact with obstructions while traveling can be suppressed. This enables charging of the vehicle 1 while traveling, without compromising safety.

The lift 10 in the vehicle 1 may include the frame 12, multiple links (in one embodiment, first links 24 and second links 25), the first gear 26, the second gear 28, and a first drive unit (in one embodiment, the first motor 27). The power receiving coil 2 is attached to the frame 12. One end of each of the links is linked to the frame 12. The first gear 26 is attached to a link of the links, and is configured to vary the angle of the links with respect to the vehicle body by rotating. The second gear 28 serves as a worm gear that meshes with the first gear 26. The first drive unit is configured to drive the second gear 28.

By driving the first drive unit, the second gear 28 and the first gear 26 meshing with the second gear 28 rotate together, and the angle of the link with respect to the vehicle body of the vehicle 1 changes. Thus, positions of the frame 12 that is attached to the end of the link, and the power receiving coil 2, change in the up-down direction. The link is subjected to a load under the weight of the frame 12 and the power receiving coil 2, and accordingly tends to rotate in the opposite direction from the direction in which the link is rotated by the driving of the first drive unit. However, by using a worm gear as the second gear 28, the second gear 28 is suppressed from rotating under the weight of the frame 12 and the power receiving coil 2 in the direction opposite to the direction in which it is rotated by the driving of the first drive unit. This enables the positions of the power receiving coil 2 and the power feed coil 201 to be maintained even when driving by the first drive unit is stopped. That is to say, providing a separate mechanism to suppress the positions of the power receiving coil 2 and the power feed coil 201 from changing under the weight of the frame 12 and the power receiving coil 2 is unnecessary, and thus the size and weight of the mechanism can be reduced. Furthermore, power can be suppressed from being continuously consumed in order to continuously maintain the positions of the power receiving coil 2 and the power feed coil 201.

The holder 9 in the vehicle 1 may have the grips (in one embodiment, frontward grip 29, rearward grip 34). The grips are configured to grip the gripped portion (in one embodiment, flange portion 207) that the power feed coil includes. The grips may be configured to move between the non-gripping position Png, at which the gripped portion is not gripped, and the gripping position Pg, at which the gripped portion can be gripped. The vehicle 1 may be provided with the second drive unit (in one embodiment, second motor 38) configured to move the grip between the non-gripping position Png and the gripping position Pg. There are various ways conceivable for an arrangement in which the power feed coil 201 is in a state of being held in close proximity to the power receiving coil 2, such as using a magnet, or the like. Adopting a configuration in which the grips grip the gripped portion, as in the disclosure, facilitates stably holding the power feed coil 201 in close proximity to the power receiving coil 2. Also, in the disclosure, the grips are movable between the gripping position Pg and the non-gripping position Png by the second drive unit. This makes unnecessary the manual work of a person crawling under the vehicle body and placing the power feed coil 201 close to the power receiving coil 2 so as to be held in place, for example. Also, in the disclosure, employing a motor or the like as the second drive unit enables electrically driving the grips, thereby improving work efficiency.

The grips (in one embodiment, frontward grip 29, rearward grip 34) of the vehicle 1 may have a first end and a second end. The first end is supported by the frame 12 to which the power receiving coil 2 is attached. The second end serves as a gripping portion that grips the gripped portion (in one embodiment, flange portion 207). The second end may be situated upward from the lower end of the power receiving coil 2 at the non-gripping position Png, and may be situated downward from the power receiving coil 2 at the gripping position Pg. Thus, when the power receiving coil 2 in the state in which the power feed coil 201 is not being gripped is positioned near the minimum ground clearance H0, the grip is not situated downward from the minimum ground clearance H0. This suppresses the grips from interfering with travel of the vehicle 1. Note that the first end of each of the frontward grip 29 and the rearward grip 34 may be in a supported arrangement of being supported by the frame 12 directly or indirectly. In one example of this embodiment, the frontward grip 29 is attached to the front-side shaft member 20, and thus is indirectly supported by the frame 12. The rearward grip 34 is attached to the rear-side shaft member 21, and thus is indirectly supported by the frame 12.

The lift 10 in the vehicle 1 may be configured to position the power receiving coil 2 downward from the minimum ground clearance H0. For example, ensuring the minimum ground clearance H0 is unnecessary while the vehicle is parked. The lift 10 disposes the power receiving coil 2 at a position close to the ground (lower end position PL) under a predetermined condition, for example, while the vehicle is parked. This allows the power feed coil 100 that is embedded in a parking lot at home, for example, and the power receiving coil 2 to be brought closer to each other, thereby enabling improvement in charging efficiency.

The various examples described above can be combined as appropriate.

What is claimed is:

1. A vehicle comprising:
a towing member configured to link with a towed object;
an in-vehicle battery that serves as a secondary battery in the vehicle;
a power receiving coil that is disposed under a floor panel of the vehicle, and that is configured to receive a magnetic flux generated in a power feed coil that is coupled to an external battery installed in the towed object, and generate power to be used for charging the in-vehicle battery;
a holder configured to hold the power feed coil directly below the power receiving coil; and
a lift configured to raise and lower the power receiving coil, wherein the lift is configured to:
position the power receiving coil at a first height corresponding to a minimum ground clearance of the vehicle, in a state in which the power feed coil is not held by the holder; and
position the power receiving coil at a second height, which is a height of the power receiving coil at which the power feed coil is at a height that corresponds to the minimum ground clearance of the vehicle, in a state in which the power feed coil is held by the holder.

2. The vehicle according to claim 1, wherein the lift comprises:
a frame to which the power receiving coil is attached;
a plurality of links, the links each having one end linked to the frame;
a first gear that is attached to a link of the links and that is configured to vary an angle of the links with respect to a vehicle body of the vehicle by rotating;
a second gear that serves as a worm gear meshing with the first gear; and
a first drive unit configured to drive the second gear.

3. The vehicle according to claim 1, further comprising a second drive unit wherein:
the holder comprises a grip configured to grip a gripped portion that the power feed coil comprises;
the grip is configured to move between a non-gripping position at which the gripped portion is not gripped and a gripping position at which the gripped portion is gripped; and
the second drive unit is configured to move the grip between the non-gripping position and the gripping position.

4. The vehicle according to claim 3, wherein:
the grip comprises
a first end that is supported by a frame to which the power receiving coil is attached, and
a second end that serves as a gripping portion that grips the gripped portion; and
the second end is situated upward from a lower end of the power receiving coil in the non-gripping position, and is situated downward from the power receiving coil in the gripping position.

5. The vehicle according to claim 1, wherein the lift is configured to position the power receiving coil below the minimum ground clearance of the vehicle when the vehicle is in a predetermined condition.
